(19) United States
(12) Patent Application Publication
(10) Pub. No.: US 2020/0050522 A1
(43) Pub. Date: Feb. 13, 2020

(54) HIGHLY AVAILABLE CLOUD-BASED DATABASE SERVICES

(71) Applicant: REMOTE DBA EXPERTS, LLC, Warrendale, PA (US)

(72) Inventors: Cashton COLEMAN, Plano, TX (US); Robert Joseph DEMPSEY, Plano, TX (US)

(21) Appl. No.: 16/539,232

(22) Filed: Aug. 13, 2019

Related U.S. Application Data
(60) Provisional application No. 62/718,246, filed on Aug. 13, 2018.

(51) Int. Cl. G06F 11/20; G06F 11/14; G06F 9/455

(52) U.S. Cl. CPC G06F 11/203; G06F 11/1484; G06F 2009/4557; G06F 9/45533; G06F 2201/815; G06F 11/1448

(57) ABSTRACT

A management fabric for a server cluster may receive an indication of a failover condition in the server cluster for a virtual machine executing in the server cluster, where a first database program executing at the virtual machine communicates with one or more data storage devices that is attached to the virtual machine, and where a hostname is associated with the virtual machine. In response to receiving the indication of the failover condition, the server cluster may perform failover, including attaching the one or more data storage devices to a backup virtual machine associated with the one or more data storage devices, so that a second database program executing at the backup virtual machine is able to communicate with the one or more data storage devices, where the backup virtual machine is already executing in the server cluster, and associating the hostname with the backup virtual machine.

### CROSS-REFERENCE TO RELATED APPLICATIONS

This application claims the benefit of U.S. Provisional Application No. 62/718,246 filed Aug. 13, 2018, the entire content of which is hereby incorporated by reference.

### BACKGROUND

Cluster computing typically connects a plurality of computing nodes to gain greater computing power and better reliability using low or lower cost computers. Connecting a number of computers or servers via a fast network can form a cost-effective alternative to a single high-performance computer. In cluster computing, the activities of each node (e.g., computer or server) in the cluster are managed by a clustering middleware that sits atop each node, which enables users to treat the cluster as one large, cohesive computer.

A server cluster is a group of at least two independent computers (e.g., servers) connected by a network and managed as a single system in order to provide high availability of services for clients. Server clusters include the ability for administrators to inspect the status of cluster resources, and accordingly balance workloads among different servers in the cluster to improve performance. Such manageability also provides administrators with the ability to update one server in a cluster without taking important data and applications offline. Server clusters are used in critical database management, file and intranet data sharing, messaging, general business applications, and the like.

The description provided in the background section should not be assumed to be prior art merely because it is mentioned in or associated with the background section. The background section may include information that describes one or more aspects of the subject technology.

### BRIEF SUMMARY

Aspects of the present disclosure are directed to establishing highly available cloud-based database services that enables traditional databases to operate in a cloud environment enables such databases to survive common failures and to enable the databases to be maintained with minimal downtime. Virtual machines may execute on servers of a server cluster to provide database services via data storage devices attached to the virtual machines. When the server cluster detects a failover condition for a virtual machine in the server cluster, such that the virtual machine is potentially no longer able to provide database services, the server cluster may failover from the virtual machine to a standby virtual machine executing in the server cluster to continue providing database services. The server cluster may detach, the data storage device used by the virtual machine to provide database services and may attach the data storage device to the standby virtual machine. The server cluster may also update the domain name service (DNS) of the server cluster to forward network traffic intended for the virtual machine to the standby network machine. In this way, the server cluster is able to maintain high availability of database services in the cloud.

According to certain aspects of the present disclosure, a computer-implemented method is provided. The method includes receiving an indication of a failover condition in a server cluster for a virtual machine executing in the server cluster, wherein a first database program executing at the virtual machine communicates with one or more data storage devices that is attached to the virtual machine, and wherein a hostname is associated with the virtual machine. The method further includes, in response to receiving the indication of the failover condition, performing failover of the server cluster, including: attaching the one or more data storage devices to a backup virtual machine associated with the one or more data storage devices, so that a second database program executing at the backup virtual machine is able to communicate with the one or more data storage devices, wherein the backup virtual machine is already executing in the server cluster, and associating the hostname with the backup virtual machine.

According to certain aspects of the present disclosure, a computing apparatus is provided. The apparatus includes a processor. The apparatus further includes a memory storing instructions that, when executed by the processor, configure the apparatus to: receive an indication of a failover condition in a server cluster for a virtual machine executing in the server cluster, wherein a first database program executing at the virtual machine communicates with one or more data storage devices that is attached to the virtual machine, and wherein a hostname is associated with the virtual machine; and in response to receiving the indication of the failover condition, perform failover of the server cluster, including: attach the one or more data storage devices to a backup virtual machine associated with the one or more data storage devices, so that a second database program executing at the backup virtual machine is able to communicate with the one or more data storage devices, wherein the backup virtual machine is already executing in the server cluster, and associating the hostname with the backup virtual machine.

According to certain aspects of the present disclosure, a non-transitory computer-readable storage medium is provided. The computer-readable storage medium includes instructions that when executed by a computer, cause the computer to: receive an indication of a failover condition in a server cluster for a virtual machine executing in the server cluster, wherein a first database program executing at the virtual machine communicates with one or more data storage devices that is attached to the virtual machine, and wherein a hostname is associated with the virtual machine; and in response to receiving the indication of the failover condition, perform failover of the server cluster, including: attach the one or more data storage devices to a backup virtual machine associated with the one or more data storage devices, so that a second database program executing at the backup virtual machine is able to communicate with the one or more data storage devices, wherein the backup virtual machine is already executing in the server cluster, and associate the hostname with the backup virtual machine.

According to certain aspects of the present disclosure, an apparatus is provided. The apparatus includes means for receiving an indication of a failover condition in a server cluster for a virtual machine executing in the server cluster, wherein a first database program executing at the virtual machine communicates with one or more data storage devices that is attached to the virtual machine, and wherein a hostname is associated with the virtual machine. The apparatus further includes means for, in response to receiving the indication of the failover condition, performing failover of the server cluster, including: means for attaching the one or more data storage devices to a backup virtual machine associated with the one or more data storage devices, so that a second database program executing at the backup virtual machine is able to communicate with the one or more data storage devices, wherein the backup virtual machine is already executing in the server cluster, and means for associating the hostname with the backup virtual machine.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and incorporated in and constitute a part of this specification, illustrates disclosed embodiments and together with the description serve to explain the principles of the disclosed embodiments. In the drawings:

FIGS. 1A and 1B illustrates an example server cluster for highly available cloud-based database services in accordance with aspects of the present disclosure

FIG. 2 is a block diagram illustrating an example management fabric, subscriber and servers in the server cluster of FIGS. 1A and 1B according to certain aspects of the disclosure.

FIG. 3 is a flowchart illustrating an example process of performing failover in a server cluster.

FIG. 4 is a flowchart illustrating an example process of performing failover in a server cluster.

FIG. 5 is a block diagram illustrating an example computer system with which the management fabric and the servers of FIGS. 1A-4 can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementation in which the subject technology may be practiced. As those skilled in the art would realize, the described implementations may be modified in various different ways, all without departing from the scope of the present disclosure. Accordingly, the drawings and descriptions are to be regarded as illustrative in nature and not restrictive.

### General Overview

The disclosed system provides for establishing highly available cloud-based database services. Servers operating within a server cluster that implements a highly available database service may have the ability to failover, which is switching to a redundant or standby application, computer server, system, hardware component or network, upon the failure or abnormal termination of a previously active application, server, system, hardware component, or network. In this way, the disclosed system may enable traditional databases to operate in a cloud environment enables such databases to survive common failures and to enable the databases to be maintained with minimal downtime

Server clusters may include asymmetric clusters or symmetric clusters. In an asymmetric cluster, a standby server may only exit in order to take over for another server in the server cluster in the event of a failure. This type of server cluster potentially provides high availability and reliability of services while having redundant and unused capability. A standby server may not perform useful work when on standby even when it is as capable or more capable than the primary server. In a symmetric server cluster, every server in the cluster may perform some useful work and each server in the cluster may be the primary host for a particular set of applications. If a server fails, the remaining servers continue to process the assigned set of applications while picking up new applications from the failed server. Symmetric server clusters may be more cost effective compared with asymmetric server clusters, but, in the event of a failure, the additional load on the working servers may also cause the working servers to fail as well, thereby leading to the possibility of a cascading failure.

Each server in a server cluster may execute one or more instantiations of database applications. Underlying each of these database applications may be database engine, such as MICROSOFT TRANSACTED STRUCTURED QUERY LANGUAGE or T-SQL (commonly known as SQL SERVER) or ORACLE RDBMS. T-SQL is a special purpose programming language designed for managing data in relational database management systems. Originally built on relational algebra and tuple relational calculus, its scope includes data insert, query, update and delete functionality, schema creation and modification, and data access control. ORACLE RDBMS is a multi-model database management system produced and marketed by ORACLE CORPORATION and is a database commonly used for running online transaction processing, data warehousing and mixed database workload.

MICROSOFT SQL SERVER is another popular database engine that servers use as a building block for many larger custom applications. Each application built using SQL SERVER and the like may typically communicates with a single instance of the database engine using that server's name and Internet Protocol (IP) address. Thus, servers with many applications depending on SQL SERVER to access a database may normally run an equal number of instances of SQL SERVER. In most cases, each instance of SQL SERVER runs on a single node (virtual or physical) within the server cluster, each with its own name and address. If the node (server) that is running a particular instance of SQL SERVER fails, the databases are unavailable until the system is restored on a new node with a new address and name. Moreover, if the node becomes heavily loaded by one or more applications, the performance of the database and other applications can be degraded.

Highly available server clusters (failover clusters) may improve the reliability of server clusters. In such a server cluster architecture, redundant nodes, or nodes that are not fully utilized, exist that are capable of accepting a task from a node or component that fails. High availability server clusters attempt to prevent single point failures. As one of reasonable skill in the relevant art can appreciate, the establishment, configuration, and management of such clusters may be complicated.

There are numerous cluster approaches, but in a typical system, each computer utilizes identical operating systems, often operating on the same hardware, and possesses local memory and disk space storage. But the network may also have access to a shared file server system that stores data pertinent to each node as needed.

A cluster file system or shared file system enables members of a server cluster to work with the same data files at the same time. These files are stored on one or more storage disks that are commonly assessable by each node in the server cluster. A storage disk, from a user or application perspective, is a device that may merely data. Each disk has a set number of blocks from which data can be read or to which data can be written. For example, a storage disk can receive a command to retrieve data from block 1234 and send that data to computer A. Alternatively, the disk can receive a command to receive data from computer B and write it to “block 5678.” These disks are connected to the computing devices issuing instructions disk interfaces. Storage disks do not create files or file systems; they are merely repositories of data residing in blocks.

Operating systems operating on each node include a file system that creates and manages files and file directories. It is these systems that inform the application where the data is located on the storage disk. The file system maintains some sort of table (often called a file access table) that associates logical files with the physical location of the data, i.e. disk and block numbers. For example, “File ABC” is found in “Disk 1, blocks 1234, 4568, 3412 and 9034,” while “File DEF” is found at “Disk 2, blocks 4321, 8765 and 1267.” The file system manages the storage disk. Thus, when an application needs “File ABC,” it goes to the file system and requests “File ABC.” The file system then retrieves the data from the storage disk and delivers it to the application for use.

As one of reasonable skill in the relevant art will appreciate, the description above is rudimentary and there are multiple variations and adaptations to the architecture presented above. A key feature of the system described above, however, is that all of the applications running on an operating system use the same file system. By doing so, the file system guarantees data consistency. For example, if “File ABC” is found in, among others, “block 1234,” then “File DEF” will not be allocated to “block 1234” to store additional data unless “File ABC” is deleted and the “blocks 1234” are released.

A cluster file system may resolve these potential issues by enabling a multi-computer architecture (computing cluster) to share a plurality of storage disks without having the potential limitation of a single file system server. Such a system synchronizes the file allocation table (or the like) resident on each node so that each node knows the status of each storage disk. The cluster file system communicates with the file system of each node to ensure that each node possesses accurate information with respect to the management of the storage disks. The cluster file system therefore acts as the interface between the file systems of each node while applications operating on each node seek to retrieve data from and write data to the storage disks.

A single file server, however, may be a limitation to an otherwise flexible cluster of computer nodes. Another approach to common data storage is to connect a plurality of storage devices (e.g., disks) to a plurality of computing nodes. Such a Storage Area Network (SAN) enables any computing node to send disk commands to any disk. But such an environment creates disk space allocation inconsistency and file data inconsistency. For example, two computers can independently direct data to be stored in the same blocks. These issues may make it difficult to use shared disks with a regular file system.

Using the cloud is yet another evolution of cluster computing. Cloud computing is an information technology (IT) paradigm that enables ubiquitous access to shared pools of configurable system resources and higher-level services that can be rapidly provisioned with minimal management effort, often over the Internet. Cloud computing relies on sharing of resources to achieve coherence and economies of scale, similar to a public utility.

Third-party clouds enable organizations to focus on their core businesses instead of expending resources on computer infrastructure and maintenance. Advocates note that cloud computing allows companies to avoid or minimize up-front IT infrastructure costs. Proponents also claim that cloud computing allows enterprises to get their applications up and running faster, with improved manageability and less maintenance, and that it enables IT teams to more rapidly adjust resources to meet fluctuating and unpredictable demand. Cloud providers typically use a “pay-as-you-go” model, which can lead to unexpected operating expenses if administrators are not familiarized with cloud-pricing models. Cloud computing provides a simple way to access servers, storage, databases and a broad set of application services over the Internet. A cloud services platform owns and maintains the network-connected hardware required for these application services, while the customer provision and use what is need via a web application.

Applications can also operate in a virtual environment that is created on top of one or more nodes in a cluster (in the cloud or at a data center) using the same approach to access data. One of reasonable skill in the relevant art will recognize that virtualization, broadly defined, is the simulation of the software and/or hardware upon which other software runs. This simulated environment is often called a virtual machine (“VM”). A virtual machine is thus a simulation of a machine (abstract or real) that is usually different from the target (real) machine (where it is being simulated on). Software executed on these virtual machines is separated from the underlying hardware resources. For example, a computer that is running Microsoft Windows may host a virtual machine that looks like a computer with the Ubuntu Linux operating system.

Virtual machines may be based on specifications of a hypothetical computer or may emulate the computer architecture and functions of a real-world computer. There are many forms of virtualization, distinguished primarily by the computing architecture layer, and virtualized components, which may include hardware platforms, operating systems, storage devices, network devices, or other resources.

A shared storage scheme is one way to provide the virtualization stack described above. One suitable approach to shared storage is a disk or set of disks that are access-coordinated to the servers participating in a cluster. One such system is MICROSOFT CLUSTER SERVICE (MSCS). MICROSOFT CLUSTER SERVICE may require strict adherence to a Hardware Compatibility List (“HCL”) that demands each server possess the same edition and version of the operating system and licensing requirements (i.e. SQL SERVER ENTERPRISE vs. SQL SERVER STANDARD). However, the complex implementation and licensing cost to such systems may be a major roadblock for most enterprises.

A failover system in these environments may require a cluster file system, which is a specialized file system that is shared between the nodes by being simultaneously mounted on multiple servers allowing concurrent access to data. Cluster file systems may be complex and may require significant expenditure of time and capital resources to set up, configure, and maintain.

Cloud computing also provides redundant highly available services using various forms of failover systems. Accordingly shifting information technology needs of an enterprise from a corporate data center model (server cluster) to third-party cloud services can be economically beneficial to the enterprise provided that such cloud services are highly available. Such cloud database services may be required to remain reliable, available, accountable and the cost of do such services may need to be predictable, forecastable and reasonable.

Many database platforms such as ORACLE were not originally designed for cloud-based operations. These monolithic databases were originally conceived to operate in standalone data centers and are widely used in enterprise data center. While modifications to such platforms like ORACLE have made the useable in the cloud the enterprises that use such systems are looking for a cost-effective means to shift away from enterprise owned and maintained data centers without having to reinvest in new application software and similar infrastructure needs. Enterprises may not want to change the status quo and yet may desire to maintain the availability of their data.

Accordingly, it may potentially be desirable to provide highly available and reliable traditional database platforms on cloud services to reduce failover or delays in server cluster environments, so that services may be moved quickly from a failed or failing machine to a new machine that is ready and capable of performing an assigned task making the data highly available. Aspects of the present disclosure solves the technical problems described herein by implementing a highly available database platform system operating on the cloud that is consistent and compatible with traditional database technology. Aspects of the present disclosure provides for the high availability of data stored in traditional database systems, such as ORACLE, on the cloud.

In one example, an auto recovery system is implemented in which a single stand along server operating a traditional database system includes a monitoring system that detects when the server is not available. The auto recovery system stops the virtual machine, detaches the data store, starts a new virtual machine, reattaches the data store, and brings the system back on line. Recall that in the cloud when a virtual machine is stopped and then started it lands on a different physical server with minimal loss of transactional data.

In another example, an auto recovery system may provide highly available data on a cloud-based system by creating a secondary (standby) virtual machine that is up and running. In this example, a primary and a secondary virtual machine operate at the same time. The primary virtual machine is attached to the data store. That is to say that the data disk is mounted to the primary virtual machine and operates normally. The secondary virtual machine is running but sits idle.

In the event of a failover situation in which the primary is not available or it senses an upcoming failure, or similar situation exists, the invention stops the database software inside the primary virtual machine, dismounts the disk, detach the disk at the cloud level from the virtual machine, reattached the disk to the secondary virtual machine, tell the software inside the secondary virtual machine to mount the disk and start the application. Then the secondary virtual machines may become the new primary virtual machine. In this example, the auto recovery system uses a “warm standby” virtual machine using the same disk but is not touching the disk until it receives such an instruction. The secondary virtual machine knows of the same disk as the primary. This may distinct from operation a duplicate machine that has no association with the disk and the data stored within the disk.

The auto recovery system disclosed herein does not wait for the virtual machines to shut down and restart. Instead, it may only be the database software that is turned off and then reinitiated on a secondary, already operating, virtual machine. In yet another example, a router can use a common logical piece of data located at different physical locations that can be redirected as needed.

### Example System Architecture

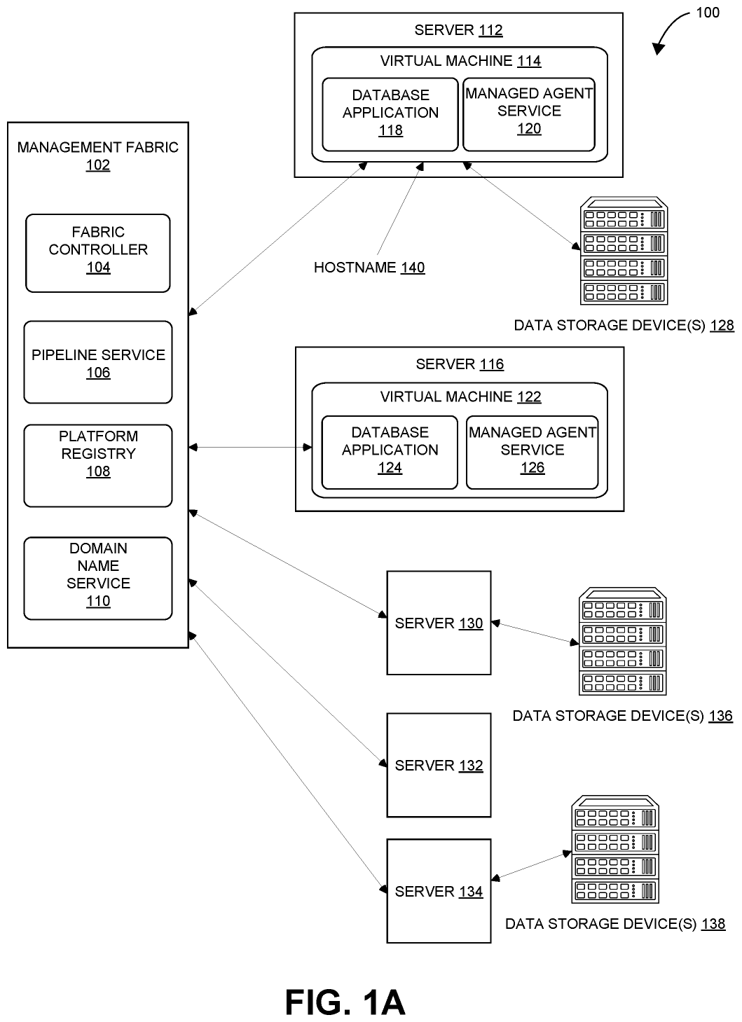

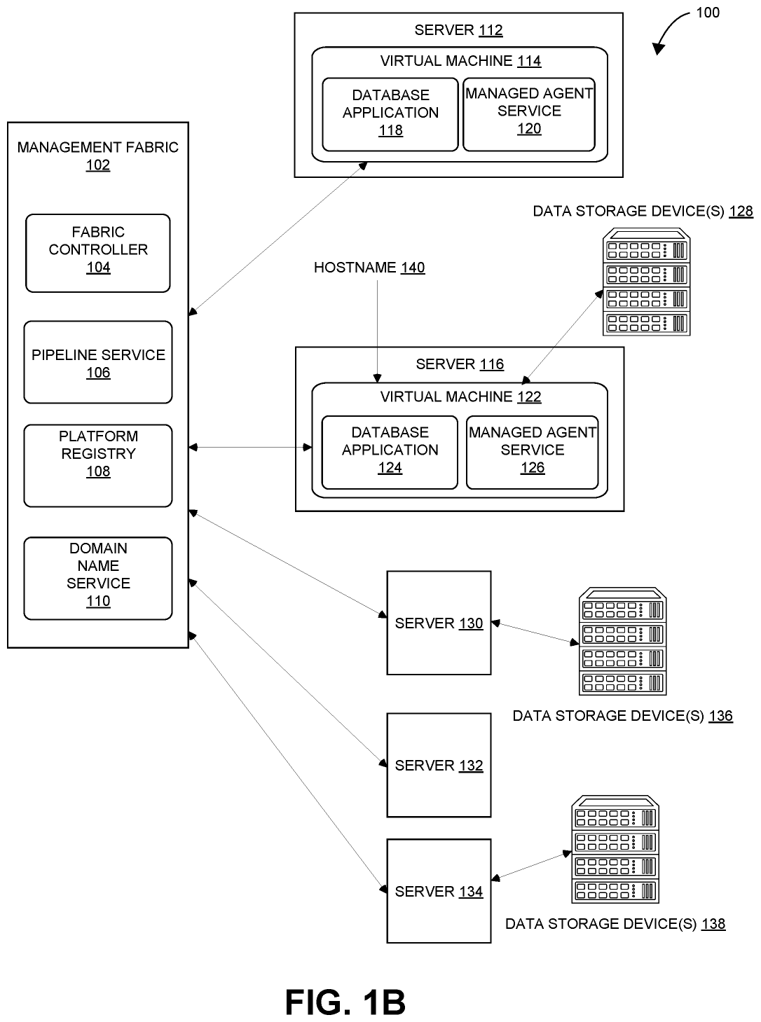

FIGS. 1A and 1B illustrate an example server cluster for highly available cloud-based database services in accordance with aspects of the present disclosure. The highly available cloud-based database services may be implemented by a server cluster. Virtual machines may execute on servers of a server cluster to provide cloud-based database services. The virtual machines may connect to data storage devices on which databases may be stored, and database applications, such as database engines, database management system applications, and the like, may execute on the virtual machines to retrieve, manage, and update the data stored by the databases in the data storage devices connected to the virtual machines. In this way, the virtual machines may act as database servers to provide database services. As discussed above, the virtual machines may provide database services for traditional database systems that are not necessarily designed for use in the cloud. By utilizing a server cluster of virtual machines to provide database services for these database systems, such database systems may be “cloudified” to enable these database systems to operate in a cloud environment.

In addition to virtual machines executing on servers that are connected to data storage devices to provide database services, a server cluster may also include one or more virtual machines executing on servers that are not connected to data storage devices and therefore do not currently provide database services. Instead, these virtual machines are on standby to takeover for a virtual machine that is providing database services when a failover condition occurs for the virtual machine that is providing database services. When a failover condition occurs for a virtual machine that is providing database services (also referred to as a “primary virtual machine”), the server cluster may detach the data storage devices from the primary virtual machine and may attach the data storage devices to a standby virtual machine that is executing in the server cluster. The server cluster may also route network traffic directed to the primary virtual machine to the standby virtual machine that is now connected to the data storage devices. In this way, the server cluster is able to quickly recover from a failover condition occurring at a primary virtual machine that is providing database services by using a standby virtual machine to continue providing the same database services provided by the primary virtual machine, thereby providing for highly available cloud-based database services.

As shown in FIG. 1A, an example server cluster 100 includes server 112, server 116, server 130, server 132, server 134 one or more data storage device(s) 128, one or more data storage device(s) 136, one or more data storage device(s) 138, and management fabric 102 that together implements a highly available could-based database service. Server 112, server 116, server 130], server 132, and server 134 of server cluster 100 can be any device or devices having an appropriate processor, memory, and communications capability for hosting virtual machines that may execute to provide database services. For example, server 112, server 116, server 130], server 132, and server 134 of server cluster 100 may include any computing devices, server devices, server systems, and the like. One or more data storage device(s) 128, one or more data storage device(s) 136, and one or more data storage device(s) 138 may be any suitable data storage devices, such as hard disks, magnetic disks, optical disks, solid state disks, and the like.

In the example of FIG. 1A, server 112 is operably coupled to data storage device(s) 128 to provide database services. Similarly, server 130 is operably coupled to data storage device(s) 136 to provide database services, and server 134 is operably coupled to data storage device(s) 138 to provide database services. Furthermore, server cluster 100 may also include server 116 and server 132 that execute within server cluster 100 but are not currently operably coupled to any data storage devices. Instead server 116 and server 132 may act as standby servers in case server cluster 100 to take over from one of server 112, server 130, or server 134 when failover occurs at one of these servers.

Server cluster 100 may include management fabric 102 to manage server cluster 100 and to facilitate failover of nodes (e.g., virtual machines) within server cluster 100. Management fabric 102 can be any device or devices having appropriate processor, memory, and communication capability to manage server cluster 100 and to facilitate the failover of nodes within server cluster 100. Management fabric 102 may include fabric controller 104, pipeline service 106, platform registry 108, and domain name service 110. Fabric controller 104, pipeline service 106, platform registry 108, and domain name service 110 may communicate with each other via a private network.

Fabric controller 104 is operable to provide core automation and orchestration components within server cluster 100. Fabric controller 104 is operable to interact with data that resides in platform registry 108 to determine actions that may need to be performed in server cluster 100. Fabric controller 104 may evaluate the operating state of all of the objects in server cluster 100 which are registered in platform registry 108 to affect any necessary movements of components. Platform registry 108 may also interact directly with cloud platforms such as MICROSOFT AZURE and AMAZON WEB SERVICES) to perform various activities, such as the provisioning, management, and tear-down of virtual machines, internet protocol (IP) networks, storage devices, and domain name services (e.g., domain name service 110).

Platform registry 108 is operable to provide state information for the entire server cluster 100. Platform registry 108 stores information about all of the objects of server cluster 100 in a registry database, such as information regarding the nodes and data storage devices of server cluster 100, and provides security, billing, and telemetry information to the various components in the highly available cloud-based database services system encompassed by server cluster 100.

Pipeline service 106 is operable to enable components of management fabric 102, such as fabric controller 104, to communicate with servers in server cluster 100, such as server 112, server 116, server 130, server 132, and server 134. Pipeline service 106 may be a portion of a platform that provides a unified means for a managed agent service such as managed agent service 120 or managed agent service 126 to retrieve service information from platform registry 108. Managed agent services such as managed agent service 120 and managed agent service 126 may use pipeline service 106 in order to gain access to any necessary information to function properly and to enable fabric controller 104 to move any necessary cluster components between virtual machines in server cluster 100.

Domain name service 110 may be operable to map hostnames to network addresses (e.g., Internet Protocol addresses) in server cluster 100 so that servers within server cluster 100 may be reached via their hostnames. For example, domain name service 110 may map hostname 140 associated with virtual machine 114 to the network address associated with virtual machine 114.

Virtual machine 114 executing on server 112 is an example of a primary virtual machine that is providing database services in server cluster 100 for which a failover condition may occur, and virtual machine 122 executing on server 116 is an example of a standby virtual machine that is on standby to takeover and provide database services when a failover condition occurs for a primary virtual machine. A virtual machine such as virtual machine 114 or virtual machine 122 may be software for emulating a computer system, so that they can, for example, execute operating systems that are different from the operating systems of the servers on which they execute.

Virtual machine 114 includes database application 118 and managed agent service 120 that executes in virtual machine 114 while virtual machine 122 includes database application 124 and managed agent service 126 that executes in virtual machine 122. A managed agent service, such as managed agent service 120 and managed agent service 126, may execute on virtual machines in server cluster 100 and may be operable to provide localized management functionality for their respective servers in server cluster 100. The managed agent service may be operable to perform various operations such as partitioning and formatting data storage devices attached to the virtual machine, the mounting and dismounting of such data storage devices, and the management of the database software (e.g., database application 118 and database application 124), such as starting, stopping, and/or pausing the database software. The managed agent service may also directly interact with platform registry 108 via pipeline service 106 to watch for various specified states in platform registry 108 in order to perform initial software and storage setup for the virtual machine, as well as prepare for storage snapshots, backup operations, and high availability failover events. Different managed agent services such as management fabric 102 and managed agent service 126 may communicate with each other via Representational State Transfer (REST)ful services.

In this way, a managed agent service may determine when a failover condition has occurred in the server on which they reside and to notify management fabric 102 of such a failover condition. Similarly, a managed agent service may take part in performing various tasks to enable failover in server cluster 100 from a virtual machine experiencing the failover condition to a standby virtual machine.

A database application, such as database application 118 and database application 124, may be connected to one or more data storage devices to retrieve, manage, and update the data stored by the databases in the one or more data storage devices in order to perform the functionality of a database service. While virtual machine 114 is connected to one or more data storage device(s) 128, virtual machine 122 is not connected to any data storage devices, including one or more data storage device(s) 128, because virtual machine 122 is on standby to take over for another virtual machine (e.g., virtual machine 114) when another virtual machine experiences a failover condition.

When virtual machine 122 is on standby, virtual machine 122 may be up and running and may be executing on server 116, as opposed to being shut down. Furthermore, virtual machine 122 may also be associated with data storage devices in server cluster 100 even though virtual machine 122 may not yet be connected to ant of the data storage devices in server cluster 100. This may mean that virtual machine 122 may store indications of each of the one or more data storage device(s) 128, 136, and 138 in server cluster 100, so that virtual machine 122, or that database application 124 may be setup to have the ability to connect to any of the one or more data storage device(s) 128, 136, and 138, so that virtual machine 122 knows of the data storage devices in server cluster 100.

In accordance with aspects of the present disclosure, when management fabric 102 receives an indication of a failover condition for a virtual machine executing in the server cluster, management fabric 102 may perform failover of server cluster 100 to recover from the failover condition so that server cluster 100 can remain up and running. Management fabric 102 may receive an indication of a failover condition in server cluster 100. In some examples, management fabric 102 may receive a telemetry alert from a managed agent service that is indicative of a pending failover event for a virtual machine associated with the managed agent service. For example, if a managed agent service determines, via its telemetry of an associated virtual machine, signs a diminished capability, pending failure or degraded performance in the associated virtual machine, the managed agent service may send an indication of a failover condition associated with the virtual machine to management fabric 102.

In other examples, management fabric 102 may receive, via an application programming interface (API) provided by management fabric 102, an API-initiated alert that is indicative of a failover condition for a virtual machine. For example, if an administrator of server cluster 100 is in the process of shutting down a virtual machine, such as to apply a patch to the virtual machine or for other maintenance purposes, the administrator of server cluster 100 may use the API provided by management fabric 102 to send an alert indicative of a failover condition for the virtual machine that is to be shut down.

In response to receiving an indication of a failover condition in server cluster 100, management fabric 102 may perform failover of server cluster 100 by switching to a standby virtual machine. As discussed above, management fabric 102 may perform failover of server cluster 100 without human intervention. In the example of FIG. 1A, management fabric 102 may receive an indication of a failover condition for virtual machine 114 executing on server 112 in server cluster 100. For example, managed agent service 120 executing in virtual machine 114 may determine, from its telemetry of virtual machine 114 and/or server 112, signs of diminished capacity, pending failure, or degraded performance of server 112 and/or virtual machine 114 that may be indicative of a pending failover event for server 112 and/or virtual machine 114. In response to making such a determination of the existence of signs of diminished capacity, pending failure, or degraded performance of server 112 and/or virtual machine 114, managed agent service 120 may send a telemetry alert to fabric controller 104 of management fabric 102 via pipeline service 106. In another example, management fabric 102 may receive an API-initiated alert that indicates a failover condition for a virtual machine, such as virtual machine 114.

The telemetry alert generated by managed agent service 120 and sent to management fabric 102 may include an indication of the server (e.g., server 112) and/or virtual machine (e.g., virtual machine 114) experiencing the failover condition. Similarly, the API-initiated alert may also include an indication of the virtual machine (e.g., virtual machine 114) experiencing the failover condition. Fabric controller 104 may receive the telemetry alert from managed agent service 120 or may receive the API-initiated alert, and may, based on the server and/or virtual machine indicated by the telemetry alert, determine the virtual machine that is experiencing the failover condition and determine the standby virtual machine that is to takeover providing database services from the virtual machine that is experiencing the failover condition.

In response to determining the virtual machine that is experiencing the failover condition, fabric controller 104 may start the process of decommissioning the virtual machine that is experiencing the failover condition and the process of commissioning a standby virtual machine to take over the providing of database services from the virtual machine that is experiencing the failover condition. In the example of FIG. 1A, when fabric controller 104 determines that virtual machine 114 is experiencing a failover condition, such as from a telemetry alert sent by managed agent service 120 or from an API-initiated alert, fabric controller 104 may start the process of decommissioning virtual machine 114 and the process of commissioning virtual machine 122 to take over the providing of database services using the same one or more data storage device(s) 128 connected to virtual machine 114.

To decommission virtual machine 114, managed agent service 120 executing on virtual machine 114 may stop database application 118 and may unmount one or more data storage device(s) 128 connected to virtual machine 122 in preparation for fabric controller 104 to completely detach one or more data storage device(s) 128, using a cloud API, from virtual machine 122. Fabric controller 104 may detach one or more data storage device(s) 128 from virtual machine 122 and may decommission cluster components, which may include agents, services, and software components executing in virtual machine 122 to connect database application 118 to one or more data storage device(s) 128 and to use one or more data storage device(s) 128 to act as the primary virtual machine that provides a database service using one or more data storage device(s) 128 in server cluster 100.

When virtual machine 114 has been decommissioned, fabric controller 104 may commission virtual machine 122 to take over from virtual machine 122 to provide the same database services provided by virtual machine 114 using the same one or more data storage device(s) 128 connected to virtual machine 114. Virtual machine 122 may send, via pipeline service 106, an indication to fabric controller 104 that it is ready to accept the cluster components that it may use to connect database application 124 to one or more data storage device(s) 128 and to use one or more data storage device(s) 128 to act as the primary virtual machine that provides a database service using one or more data storage device(s) 128 in server cluster 100.

In response to receiving an indication that virtual machine 122 is ready to accept the cluster components, fabric controller 104 may retrieve the cluster components from platform registry 108 and may send the cluster components to virtual machine 122. Virtual machine 122 may install the cluster components, mount one or more data storage device(s) 128, and attach itself to one or more data storage device(s) 128 using the cluster components in order to connect database application 124 to one or more data storage device(s) 128. In this way, virtual machine 122 may use database application 124 connected to one or more data storage device(s) 128 to act as a primary virtual machine that provides database services using one or more data storage device(s) 128. Managed agent service 126 may verify that virtual machine 122 possesses the cluster components needed to operate as a primary virtual machine in server cluster 100, designate virtual machine 122 as a primary virtual machine in server cluster 100, and may send an indication to management fabric 102 that server cluster 100 may resume in a running state.

Once virtual machine 114 is decommissioned, management fabric 102 may also redirect network traffic from virtual machine 114 to virtual machine 122. Management fabric 102 may reassign hostname 140 associated with virtual machine 122 so that it is associated with virtual machine 122, so that network traffic directed to hostname 140. Instead of using a floating IP address, which may be unavailable in a cloud environment, domain name service 110 may, using a cloud API, edit one or more records in domain name service 110, such as the A record and the CNAME record associated with virtual machine 114 and/or virtual machine 122, to associate hostname 140 with a network address associated with virtual machine 122.

As shown in FIG. 1B, after management fabric 102 has decommissioned virtual machine 114 and has commissioned virtual machine 122 as a primary virtual machine for providing database services using one or more data storage device(s) 128, virtual machine 122 is now attached to one or more data storage device(s) 128. Furthermore, hostname 140 is now also associated with virtual machine 122. Thus, database queries sent to hostname 140 are redirected to virtual machine 122 for processing by database application 124 and one or more data storage device(s) 128. As shown by the example of FIGS. 1A and 1B, server cluster 100 is designed in such a way as to work with the cloud instead of working with traditional data centers and datacenter concepts. In essence, FIGS. 1A and 1B describes techniques to “cloudify” traditional, monolithic databases, such as ORACLE and SQL SERVER by enabling them to survive common failures and enabling them to be maintained with minimal downtime. Example Server Cluster System

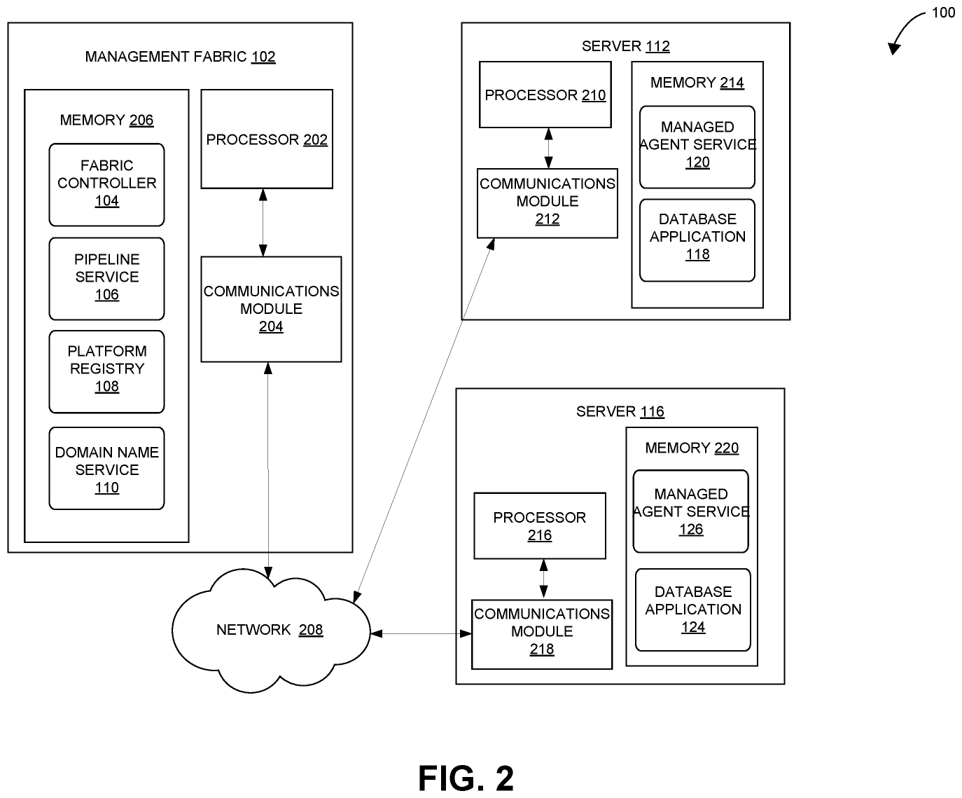

FIG. 2 is a block diagram illustrating an example management fabric, subscriber and servers in the server cluster of FIGS. 1A and 1B according to certain aspects of the disclosure. As shown in FIG. 2, management fabric 102, server 112, and server 116 in server cluster 100 are connected over network 208 via respective communications module 204, communications module 212, and communications module 218. Communications module 204, communications module 212, and communications module 218 are configured to interface with network 208 to send and receive information, such as data, requests, responses, and commands to other devices on the network. Examples of communications module 204, communications module 212, and communications module 218 can be, for example, modems or Ethernet cards.

Network 208 may include one or more network hubs, network switches, network routers, or any other network equipment, that are operatively inter-coupled thereby providing for the exchange of information between components of server cluster 100, such between management fabric 102, server 112, and server 116. Management fabric 102, server 112, and server 116 may transmit and receive data across network 208 using any suitable communication techniques. Management fabric 102, server 112, and server 116 may each be operatively coupled to network 208 using respective network links. The links coupling management fabric 102, server 112, and server 116 to network 208 may be Ethernet or other types of network connections and such connections may be wireless and/or wired connections.

Server 112 includes processor 210, communications module 212, and memory 214 that includes managed agent service 120 and database application 118. Processor 210 is configured to execute instructions, such as instructions physically coded into processor 210, instructions received from software in memory 206, or a combination of both. For example, processor 210 may execute instructions of database application 118 to provide a database service in server cluster 100.

Server 116 includes processor 216, communications module 218, and memory 220 that includes managed agent service 126 and database application 124. Processor 216 is configured to execute instructions, such as instructions physically coded into processor 216, instructions received from software in memory 214, or a combination of both. For example, processor 216 may execute instructions of database application 124 to provide a database service in server cluster 100.

Management fabric 102 includes processor 202, communications module 204, and memory 206 that includes fabric controller 104, pipeline service 106, platform registry 108, and domain name service 110. While FIG. 2 illustrates fabric controller 104, pipeline service 106, platform registry 108, and domain name service 110 as being persisted in memory 206, it should be understood that fabric controller 104, pipeline service 106, platform registry 108, and domain name service 110 may be stored across different memories in different servers and devices. Processor 202 of management fabric 102 is configured to execute instructions, such as instructions physically coded into processor 202, instructions received from software in memory 206, or a combination of both. For example, processor 202 may execute instructions of any of fabric controller 104, pipeline service 106, platform registry 108, and domain name service 110 to manage the failover of server cluster 100.

For example, processor 210 of server 116 may execute the instructions of managed agent service 120 to send a telemetry alert via network 208 to management fabric 102 to indicate a failover condition for virtual machine 122. Processor 202 of management fabric 102 may execute fabric controller 104 to receive, in the form of the telemetry alert sent by managed agent service 120, the indication of the failover condition for virtual machine 122 and, in response, perform failover of server cluster 100. To perform failover of server cluster 100, processor 202 of management fabric 102 may execute fabric controller 104 to decommission virtual machine 114 from server cluster 100 and to commission virtual machine 122 in server cluster 100.

Processor 202 of management fabric 102 may execute fabric controller 104 to communicate with virtual machine 114 via network 208 to detach and unmount one or more data storage device(s) 128 from virtual machine 114. Processor 210 of server 112 may execute the instructions of managed agent service 120 to detach and unmount one or more data storage device(s) 128 from virtual machine 122, and to decommission cluster components used by virtual machine 122 to act as a database service using one or more data storage device(s) 128.

Processor 202 of management fabric 102 may also execute fabric controller 104 to communicate with virtual machine 122 via network 208 to attach and mount the one or more data storage device(s) 128 to virtual machine 122. Processor 202 of management fabric 102 may execute fabric controller 104 to send to virtual machine 122 via network 208 cluster components that virtual machine 122 may use to connect to one or more data storage device(s) 128 and to act as a database service using one or more data storage device(s) 128. Processor 216 of server 116 may execute the instructions of managed agent service 126 to attach and mount the one or more data storage device(s) 128 and to use the cluster components to connect database application 124 to one or more data storage device(s) 128 so that virtual machine 122 may act as a database service in server cluster 100.

Processor 202 of management fabric 102 may further execute domain name service 110 to reassign hostname 140 that was associated with virtual machine 114 to virtual machine 122. For example, processor 202 of management fabric 102 may execute domain name service 110 to update one or more records in domain name service 110 to assign hostname 140 to the network address associated with virtual machine 122, thereby redirecting network traffic intended for the database service previously provided by virtual machine 114 to the database service now provided by virtual machine 122.

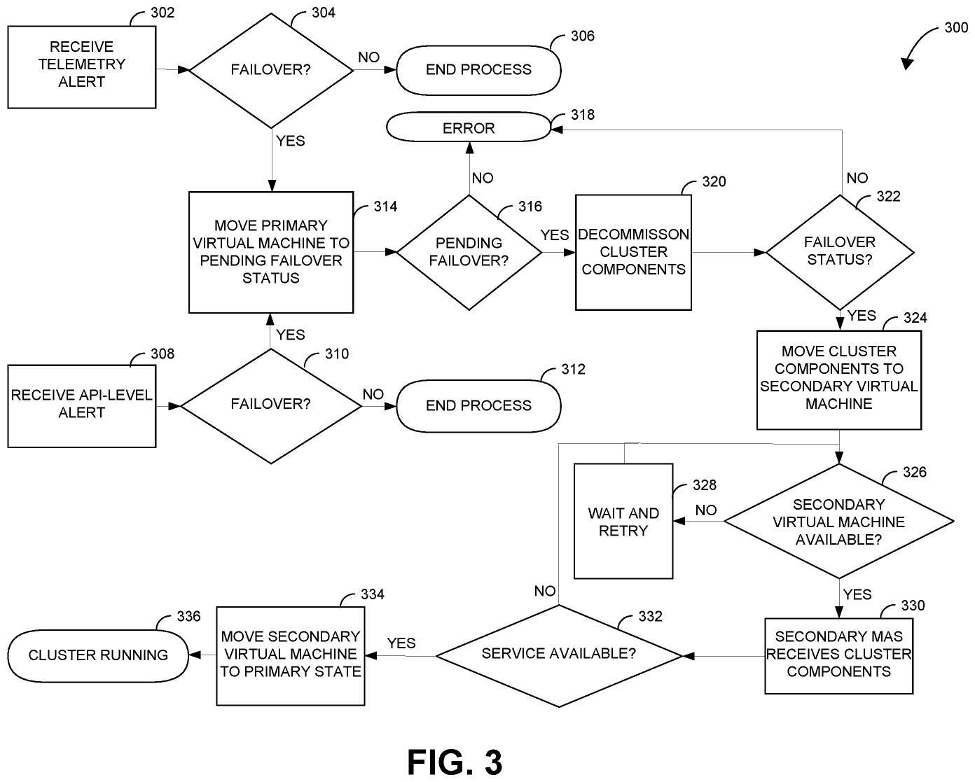

FIG. 3 is a flowchart illustrating an example process of performing failover in a server cluster. For purposes of illustration only, the example operations of FIG. 3 are described below within the context of FIGS. 1A, 1B, and 2.

As shown in FIG. 3, in process 300 may begin with management fabric 102 receiving a telemetry alert from managed agent service 120 indicating a failover condition for virtual machine 114 (302). Management fabric 102 may determine whether the failover condition has occurred for virtual machine 114 indicated by the telemetry alert (304). If management fabric 102 determines that the failover condition has not occurred for virtual machine 114, management fabric 102 may end process 300 (306). On the other hand, if management fabric 102 determines that the failover condition has occurred for virtual machine 114, management fabric 102 may proceed to perform failover of server cluster 100 by moving virtual machine 114 to a pending failover status (314).

Similarly, process 300 may also begin with management fabric 102 receiving an API-initiated alert indicating a failover condition for virtual machine 114 (308). Management fabric 102 may determine whether the failover condition has occurred for virtual machine 114 indicated by the API-initiated alert (310). If management fabric 102 determines that the failover condition has not occurred for virtual machine 114, management fabric 102 may end process 300 (312). On the other hand, if management fabric 102 determines that the failover condition has occurred for virtual machine 114, management fabric 102 may proceed to perform failover of server cluster 100 by moving virtual machine 114 to a pending failover status (314).

Once management fabric 102 moves virtual machine 114 to a pending failover alert status, management fabric 102 may determine whether the status of virtual machine 114 has indeed been changed to a pending failover alert status (316). If management fabric 102 determines that the status of virtual machine 114 has not been changed to a pending failover alert status, then management fabric 102 may determine that an error has occurred (318). If management fabric 102 determines that the status of virtual machine 114 has been changed to a pending failover alert status, then management fabric 102 may proceed to decommission the cluster components in virtual machine 114 and to detach one or more data storage device(s) 128 from virtual machine 114 (320).

Management fabric may once again determine whether the status of virtual machine 114 has indeed been changed to a pending failover alert status (322). If management fabric 102 determines that the status of virtual machine 114 has not been changed to a pending failover alert status, then management fabric 102 may determine that an error has occurred (318). If management fabric 102 determines that the status of virtual machine 114 has been changed to a pending failover alert status, then management fabric 102 may proceed to move the cluster components to virtual machine 122 and to attach one or more data storage device(s) 128 so that virtual machine 122 may provide database services in place of virtual machine 114 (324).

Once management fabric 102 has moved the cluster components to virtual machine 122, management fabric 102 may determine whether virtual machine 122 is available and providing database services in place of virtual machine 114 (326). If management fabric 102 determines that virtual machine 122 is not yet available, management fabric 102 may wait a specified amount of time (e.g., five seconds) and retry determining whether virtual machine 122 is available (328). If management fabric 102 determines that virtual machine 122 is available, management fabric 102 may determine that virtual machine 122 has received the cluster components and is attached to one or more data storage device(s) 128 (330).

Management fabric 102 may then determine whether the database service provided by virtual machine 122 is up and running and available (332). If management fabric 102 determines that virtual machine 122 is not yet available, management fabric 102 may wait a specified amount of time (e.g., five seconds) and retry determining whether virtual machine 122 is available (324). If management fabric 102 determines that virtual machine 122 is available, management fabric 102 may move the status of virtual machine 122 to a primary state (334) and may determine that server cluster 100 has recovered from the failover and is now up and running once again (336).

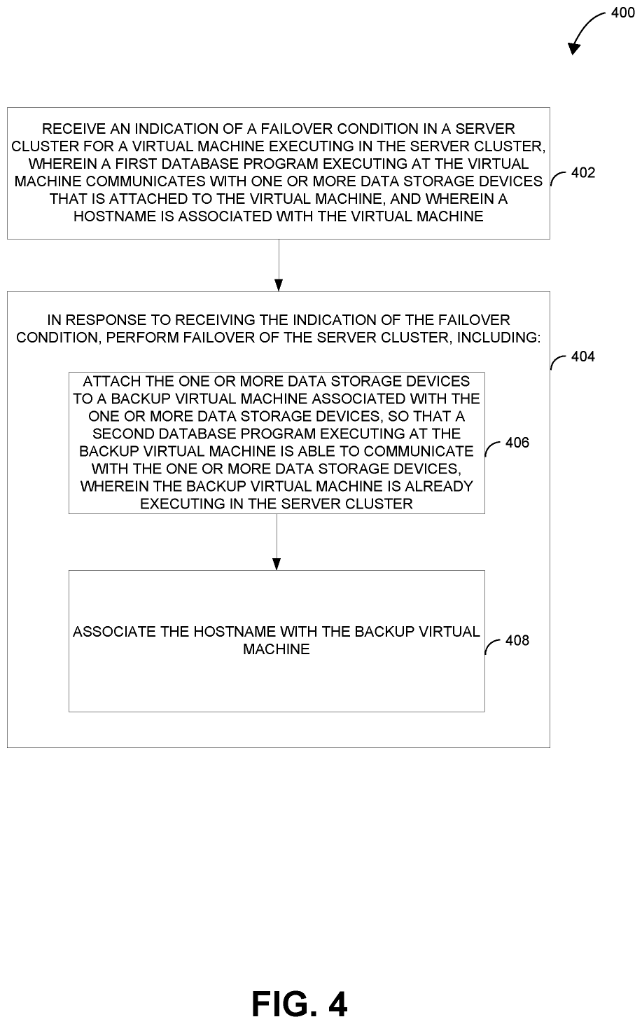

FIG. 4 is a flowchart illustrating an example process of performing failover in a server cluster. For purposes of illustration only, the example operations of FIG. 4 are described below within the context of FIGS. 1A-3.

As shown in FIG. 4, process 400 starts with management fabric 102 receiving an indication of a failover condition in a server cluster 100 for a virtual machine 114 executing in the server cluster 100, wherein a first database program 118 executing at the virtual machine 114 communicates with one or more data storage devices 128 that is attached to the virtual machine 114, and wherein a hostname 140 is associated with the virtual machine 114 (402). In response to receiving the indication of the failover condition, management fabric 102 performs failover of the server cluster 100 (404), including: attaching the one or more data storage devices 128 to a backup virtual machine 122 associated with the one or more data storage devices 128, so that a second database program 124 executing at the backup virtual machine 122 is able to communicate with the one or more data storage devices 128, wherein the backup virtual machine 122 is already executing in the server cluster 100 (406), and associating the hostname 140 with the backup virtual machine 122 (408).

In some examples, performing failover of the server cluster may further include management fabric 102 detaching the one or more data storage devices 128 from the virtual machine 114, decommissioning cluster components from the virtual machine 114, and sending the cluster components to the backup virtual machine 122. In some examples, detaching the one or more data storage devices 128 from the virtual machine 114 includes management fabric 102 unmounting the one or more data storage devices 128 from the virtual machine 114, and attaching the one or more data storage devices 128 to the backup virtual machine 122 includes management fabric 102 mounting the one or more data storage devices 128 to the backup virtual machine 122.

In some examples, associating the hostname 140 with the backup virtual machine 122 further includes management fabric 102 editing one or more records in a domain name service 110 to associate the hostname 140 with a network address of the backup virtual machine 122.

In some examples, receiving the indication of the failover condition in the server cluster 100 for the virtual machine 114 includes management fabric 102 receiving a telemetry alert indicative of a pending failover event for the virtual machine 114. In some examples, receiving the indication of the failover condition in the server cluster 100 for the virtual machine 114 includes management fabric 102 receiving an application programming interface (API)-initiated alert indicative of the failover condition for the virtual machine 114.

In some examples, the one or more data storage devices 128 includes one or more databases, and the backup virtual machine 122 executes the database program 124 that uses the one or more databases in the one or more data storage devices data storage device(s) 128 to perform database services.

### Hardware Overview

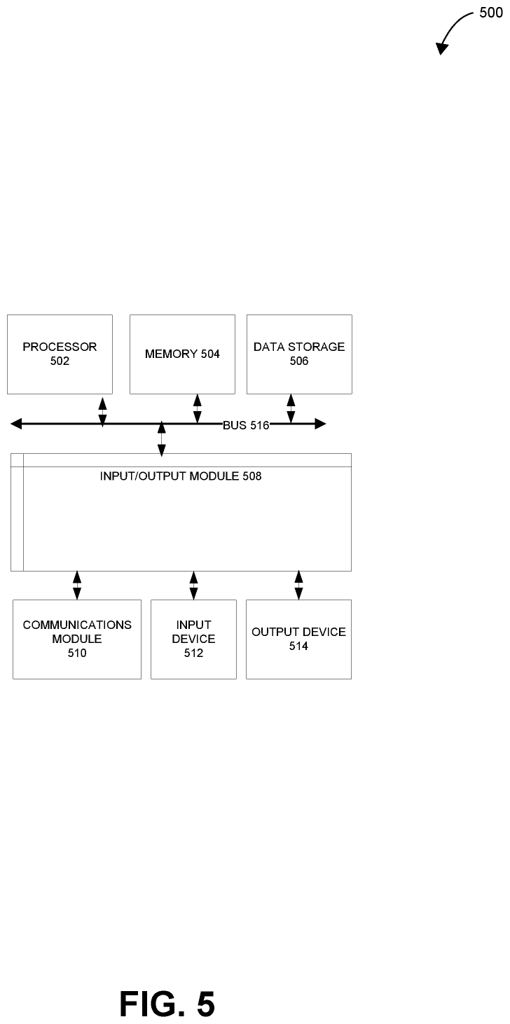

FIG. 5 is a block diagram illustrating an example computer system with which the management fabric and the servers of FIGS. 1A-4 can be implemented. In certain aspects, computer system 500 may be implemented using hardware or a combination of software and hardware, either in a dedicated server, or integrated into another entity, or distributed across multiple entities.

As shown in FIG. 5, computer system 500 (e.g., management fabric 102, server 112, and server 116) includes a bus 516 or other communication mechanism for communicating information, and a processor 502 (e.g., processor 202, processor 210, and processor 216) coupled with bus 516 for processing information. According to one aspect, the computer system 500 can be a cloud computing server of an IaaS that is able to support PaaS and SaaS services. According to one aspect, the computer system 500 is implemented as one or more special-purpose computing devices. The special-purpose computing device may be hard-wired to perform the disclosed techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques. By way of example, the computer system 500 may be implemented with one or more processors, such as processor 502. processor 502 may be a general-purpose microprocessor, a microcontroller, a Digital Signal Processor (DSP), an ASIC, a FPGA, a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 (e.g., memory 206, memory 214, and memory 220), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 516 for storing information and instructions to be executed by processor 502. The processor 502 and the memory 504 can be supplemented by, or incorporated in, a special purpose logic circuitry. Expansion memory may also be provided and connected to computer system 500 through input/output module 508, which may include, for example, a SIMM (Single In Line Memory Module) card interface. Such expansion memory may provide extra storage space for computer system 500, or may also store applications or other information for computer system 500. Specifically, expansion memory may include instructions to carry out or supplement the processes described above, and may include secure information also. Thus, for example, expansion memory may be provided as a security module for computer system 500, and may be programmed with instructions that permit secure use of computer system 500. In addition, secure applications may be provided via the SIMM cards, along with additional information, such as placing identifying information on the SIMM card in a non-hackable manner.

The instructions may be stored in the memory 504 and implemented in one or more computer program products, e.g., one or more modules of computer program instructions encoded on a computer readable medium for execution by, or to control the operation of, the computer system 500, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network, such as in a cloud-computing environment. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 516 for storing information and instructions. Computer system 500 may be coupled via input/output module 508 to various devices (e.g., management fabric 102, server 112, and server 116). The input/output module 508 can be any input/output module. Example input/output module 508 include data ports such as USB ports. In addition, input/output module 508 may be provided in communication with processor 502, so as to enable near area communication of computer system 500 with other devices.

The input/output module 508 may provide, for example, for wired communication in some implementations, or for wireless communication in other implementations, and multiple interfaces may also be used. The input/output module 508 is configured to connect to a communications module 510. Example communications module 510 (e.g., communications module 204, communications module 212, and communications module 218) include networking interface cards, such as Ethernet cards and modems.

The components of the system can be interconnected by any form or medium of digital data communication, e.g., a communication network. The communication network (e.g., network 208) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

For example, in certain aspects, communications module 510 can provide a two-way data communication coupling to a network link that is connected to a local network. Wireless links and wireless communication may also be implemented. Wireless communication may be provided under various modes or protocols, such as GSM (Global System for Mobile Communications), Short Message Service (SMS), Enhanced Messaging Service (EMS), or Multimedia Messaging Service (MMS) messaging, CDMA (Code Division Multiple Access), Time division multiple access (TDMA), Personal Digital Cellular (PDC), Wideband CDMA, General Packet Radio Service (GPRS), or LTE (Long-Term Evolution), among others. Such communication may occur, for example, through a radio-frequency transceiver. In addition, short-range communication may occur, such as using a BLUETOOTH, WI-FI, or other such transceiver.

In any such implementation, communications module 510 sends and receives electrical, electromagnetic or optical signals that carry digital data streams representing various types of information. The network link typically provides data communication through one or more networks to other data devices. For example, the network link of the communications module 510 may provide a connection through local network to a host computer or to data equipment operated by an Internet Service Provider (ISP). The ISP in turn provides data communication services through the world wide packet data communication network now commonly referred to as the “Internet”. The local network and Internet both use electrical, electromagnetic or optical signals that carry digital data streams. The signals through the various networks and the signals on the network link and through communications module 510, which carry the digital data to and from computer system 500, are example forms of transmission media.

Computer system 500 can send messages and receive data, including program code, through the network(s), the network link and communications module 510. In the Internet example, a server might transmit a requested code for an application program through Internet, the ISP, the local network and communications module 510. The received code may be executed by processor 502 as it is received, and/or stored in data storage device 506 for later execution.

In certain aspects, the input/output module 508 is configured to connect to a plurality of devices, such as an input device 512 and/or an output device 514. Example input device 512 include a keyboard and a pointing device, e.g., a mouse or a trackball, by which a user can provide input to the computer system 500. Other kinds of input device 512 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output device 514 include display devices, such as a LED (light emitting diode), CRT (cathode ray tube), LCD (liquid crystal display) screen, a TFT LCD (Thin-Film-Transistor Liquid Crystal Display) or an OLED (Organic Light Emitting Diode) display, for displaying information to the user. The output device 514 may comprise appropriate circuitry for driving the output device 514 to present graphical and other information to a user.

According to one aspect of the present disclosure, management fabric 102, server 112, and server 116 can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. Processor 502 may process the executable instructions and/or data structures by remotely accessing the computer program product, for example by downloading the executable instructions and/or data structures from a remote server through communications module 510 (e.g., as in a cloud-computing environment). In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. For example, some aspects of the subject matter described in this specification may be performed on a cloud-computing environment. Accordingly, in certain aspects a user of systems and methods as disclosed herein may perform at least some of the steps by accessing a cloud server through a network connection. Further, data files, circuit diagrams, performance specifications and the like resulting from the disclosure may be stored in a database server in the cloud-computing environment, or may be downloaded to a private storage device from the cloud-computing environment.

Computer system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer-readable medium” as used herein refers to any medium or media that participates in providing instructions or data to processor 502 for execution. The term “storage medium” as used herein refers to any non-transitory media that store data and/or instructions that cause a machine to operate in a specific fashion. Such a medium may take many forms, including, but not limited to, non-volatile media, volatile media, and transmission media. Non-volatile media include, for example, optical disks, magnetic disks, or flash memory, such as data storage device 506. Volatile media include dynamic memory, such as memory 504. Transmission media include coaxial cables, copper wire, and fiber optics, including the wires that comprise bus 516. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used in this specification of this application, the terms “computer-readable storage medium” and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire and fiber optics, including the wires that comprise bus 516. Transmission media can also take the form of acoustic or light waves, such as those generated during radio-wave and infra-red data communications. Furthermore, as used in this specification of this application, the terms “computer”, “server”, “processor”, and “memory” all refer to electronic or other technological devices. These terms exclude people or groups of people. For the purposes of the specification, the terms display or displaying means displaying on an electronic device.

In one aspect, a method may be an operation, an instruction, or a function and vice versa. In one aspect, a clause or a claim may be amended to include some or all of the words (e.g., instructions, operations, functions, or components) recited in other one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for”.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A computer-implemented method comprising:
receiving an indication of a failover condition in a server cluster for a virtual machine executing in the server cluster, wherein a first database program executing at the virtual machine communicates with one or more data storage devices that is attached to the virtual machine, and wherein a hostname is associated with the virtual machine; and
in response to receiving the indication of the failover condition, performing failover of the server cluster, including:
attaching the one or more data storage devices to a backup virtual machine associated with the one or more data storage devices, so that a second database program executing at the backup virtual machine is able to communicate with the one or more data storage devices, wherein the backup virtual machine is already executing in the server cluster, and
associating the hostname with the backup virtual machine.

2. The computer-implemented method of claim 1, wherein performing the failover of the server cluster further comprises:
detaching the one or more data storage devices from the virtual machine;
decommissioning cluster components from the virtual machine; and
sending the cluster components to the backup virtual machine.

3. The computer-implemented method of claim 2, wherein:
detaching the one or more data storage devices from the virtual machine includes unmounting the one or more data storage devices from the virtual machine; and
attaching the one or more data storage devices to the backup virtual machine includes mounting the one or more data storage devices to the backup virtual machine.

4. The computer-implemented method of claim 1, wherein associating the hostname with the backup virtual machine further comprises:
editing one or more records in a domain name service to associate the hostname with a network address of the backup virtual machine.

5. The computer-implemented method of claim 1, wherein receiving the indication of the failover condition in the server cluster for the virtual machine comprises receiving a telemetry alert indicative of a pending failover event for the virtual machine.

6. The computer-implemented method of claim 1, wherein receiving the indication of the failover condition in the server cluster for the virtual machine comprises receiving an application programming interface (API)-initiated alert indicative of the failover condition for the virtual machine.

7. The computer-implemented method of claim 1, wherein:
the one or more data storage devices includes one or more databases; and
the backup virtual machine executes the second database program that uses the one or more databases in the one or more data storage devices to perform database services.

8. A computing apparatus, the computing apparatus comprising:
a processor; and
a memory storing instructions that, when executed by the processor, configure the apparatus to:
receive an indication of a failover condition in a server cluster for a virtual machine executing in the server cluster, wherein a first database program executing at the virtual machine communicates with one or more data storage devices that is attached to the virtual machine, and wherein a hostname is associated with the virtual machine; and
in response to receiving the indication of the failover condition, perform failover of the server cluster, including:
attach the one or more data storage devices to a backup virtual machine associated with the one or more data storage devices, so that a second database program executing at the backup virtual machine is able to communicate with the one or more data storage devices, wherein the backup virtual machine is already executing in the server cluster, and
associating the hostname with the backup virtual machine.

9. The computing apparatus of claim 8, wherein the instructions that, when executed by the processor, configure the apparatus to perform the failover of the server cluster further configure the apparatus to:
detach the one or more data storage devices from the virtual machine;
decommission cluster components from the virtual machine; and
send the cluster components to the backup virtual machine.

10. The computing apparatus of claim 9, wherein:
the instructions that, when executed by the processor, configure the apparatus to detach the one or more data storage devices from the virtual machine further configure the apparatus to unmount the one or more data storage devices from the virtual machine; and
the instructions that, when executed by the processor, configure the apparatus to attach the one or more data storage devices to the backup virtual machine further configure the apparatus to mount the one or more data storage devices to the backup virtual machine.

11. The computing apparatus of claim 8, wherein the instructions that, when executed by the processor, configure the apparatus to associate the hostname with the backup virtual machine further configure the apparatus to:
edit one or more records in a domain name service to associate the hostname with a network address of the backup virtual machine.

12. The computing apparatus of claim 8, wherein the instructions that, when executed by the processor, configure the apparatus to receive the indication of the failover condition in the server cluster for the virtual machine further configure the apparatus to receive a telemetry alert indicative of a pending failover event for the virtual machine.

13. The computing apparatus of claim 8, wherein the instructions that, when executed by the processor, configure the apparatus to receive the indication of the failover condition in the server cluster for the virtual machine further configure the apparatus to receive an application programming interface (API)-initiated alert indicative of the failover condition for the virtual machine.

14. The computing apparatus of claim 8, wherein:
the one or more data storage devices includes one or more databases; and
the backup virtual machine executes the second database program that uses the one or more databases in the one or more data storage devices to perform database services.

15. A non-transitory computer-readable storage medium, the computer-readable storage medium including instructions that when executed by a computer, cause the computer to:
receive an indication of a failover condition in a server cluster for a virtual machine executing in the server cluster, wherein a first database program executing at the virtual machine communicates with one or more data storage devices that is attached to the virtual machine, and wherein a hostname is associated with the virtual machine; and
in response to receiving the indication of the failover condition, perform failover of the server cluster, including:
attach the one or more data storage devices to a backup virtual machine associated with the one or more data storage devices, so that a second database program executing at the backup virtual machine is able to communicate with the one or more data storage devices, wherein the backup virtual machine is already executing in the server cluster, and
associate the hostname with the backup virtual machine.

16. The computer-readable storage medium of claim 15, wherein the instructions that when executed by the computer, cause the computer to perform the failover of the server cluster further cause the computer to:
detach the one or more data storage devices from the virtual machine;
decommission cluster components from the virtual machine; and
send the cluster components to the backup virtual machine.

17. The computer-readable storage medium of claim 16, wherein:
the instructions that when executed by the computer, cause the computer to detach the one or more data storage devices from the virtual machine further cause the computer to unmount the one or more data storage devices from the virtual machine; and
the instructions that when executed by the computer, cause the computer to attach the one or more data storage devices to the backup virtual machine further cause the computer to mount the one or more data storage devices to the backup virtual machine.

18. The computer-readable storage medium of claim 15, wherein the instructions that when executed by the computer, cause the computer to associate the hostname with the backup virtual machine further cause the computer to:
edit one or more records in a domain name service to associate the hostname with a network address of the backup virtual machine.

19. The computer-readable storage medium of claim 15, wherein the instructions that when executed by the computer, cause the computer to receive the indication of the failover condition in the server cluster for the virtual machine further cause the computer to receive a telemetry alert indicative of a pending failover event for the virtual machine.

20. The computer-readable storage medium of claim 15, wherein the instructions that when executed by the computer, cause the computer to receive the indication of the failover condition in the server cluster for the virtual machine further cause the computer to receive an application programming interface (API)-initiated alert indicative of the failover condition for the virtual machine.
